(19) United States
(12) Patent Application Publication
(10) Pub. No.: US 2006/0027187 A1
(43) Pub. Date: Feb. 9, 2006

(54) Pet utility belt

(76) Inventor: Dimitra Nicastro, Somerset, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/191,623

(22) Filed: Jul. 28, 2005

Related U.S. Application Data
(60) Provisional application No. 60/592,709, filed on Jul. 30, 2004.

(51) Int. Cl. A62B 35/00

(52) U.S. Cl. 119/770

(57) ABSTRACT

The present invention relates to a pet utility belt including at least one compartment configured to receive items related to a dog walk and at least one clip for attachment of an item, such as a dog leash. During operation, the wearer of the belt can quickly put the belt on when he/she is ready to go out. The compartments can be pre-filled with specific items so that no additional time is spent gathering the necessary items for dog walking, such as, treats to reward the dog, bags to pick up the dog's waste, a flashlight for dusk or nighttime walking, especially around dark neighborhoods or parks, mace for possibly defending oneself against stray dogs, an umbrella in case it starts raining or the weather is bad, a wallet to hold money to allow the wearer the ability to buy sundries for themselves or the dog.

### CROSS REFERENCE TO RELATED APPLICATION

This application claims the benefit of U.S. Provisional Patent Application No. 60/592,709, filed Jul. 30, 2004, the entirety of which is hereby incorporated by reference into this application.

### BACKGROUND OF THE INVENTION

1. Field of the Invention

The present invention relates to a pet utility belt having a plurality of configured compartments and attaching means for enabling the carrying of items specifically used while walking a dog.

2. Description of Related Art

Most towns and major cities have laws that require dogs to be walked only with a leash and have subsequent laws requiring that owners clean up after their dogs. Dog walking outside is seen as a good way to exercise dogs. Especially for dog owners in an urban area, the only means to curb their dogs is by walking them outside. Currently, a person can independently carry several items, such as bags for picking up dog waste by carrying each item on their person. It is desirable to have a device which can be ready when the dog itself is ready to go out and which can combine items needed for taking a dog on a walk.

### SUMMARY OF THE INVENTION

The present invention relates to a pet utility belt including at least one compartment configured to receive items related to a dog walk and at least one clip for attachment of an item, such as a dog leash. During operation, the wearer of the belt can quickly put the belt on when he/she is ready to go out. The compartments can be pre-filled with specific items so that no additional time is spent gathering the necessary items for dog walking, such as, treats to reward the dog, bags to pick up the dog's waste, a flashlight for dusk or nighttime walking, especially around dark neighborhoods or parks, mace for possibly defending oneself against stray dogs, an umbrella in case it starts raining or the weather is bad, a wallet to hold money to allow the wearer the ability to buy sundries for themselves or the dog. In addition, a clip can be part of the belt will allow for easy hands-free use during dog walking. Also, clipping the leash to the belt allows the wearer of the belt the ability to pick up the dog's waste and still maintain control of the dog. A second clip can be used for clipping keys or a key chain to the belt to provide easy access for the wearer of the belt to lock and unlock their residence.

The invention will be more fully described by reference to the following drawings.

### BRIEF DESCRIPTION OF THE DRAWINGS

FIG. 1 is a schematic diagram of a pet utility belt in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

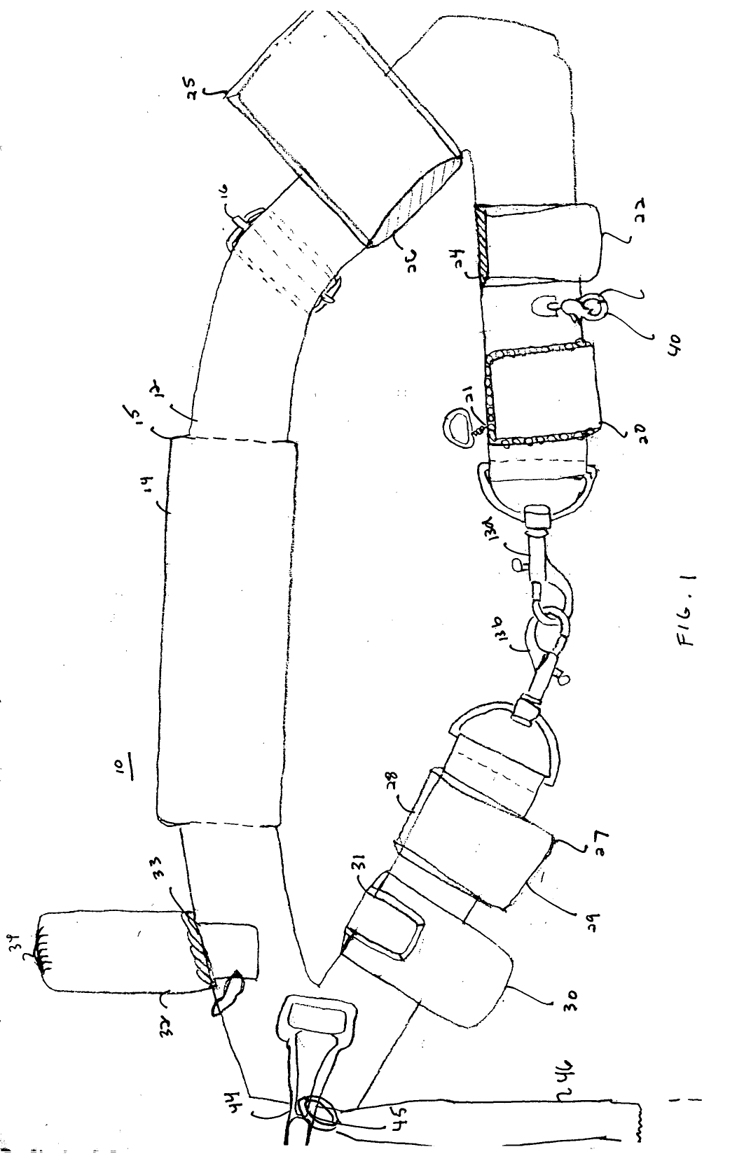

FIG. 1 is a schematic diagram of pet utility belt 10 in accordance with the teachings of the present invention. Belt 12 is configured to include at least one compartment and at least one clip for holding and attaching items that may be used during walking a dog. Belt 12 can be worn around the waist or hip area of a user and can be closed by use of clasp 13a, 13b. It will be appreciated that other means, such as a buckle, can be used to attach belt 12 to a user. Belt 12 can be made of a flexible material such as canvas or cloth. Alternatively, belt 12 can be made of a material such as leather, as long as the belt itself can be adjusted to fit various body widths. Clasps 13a, 13b can be made of metal with one clasp 13b attached on the left side of belt 12 and the second clasp 13a attached on the right side of belt 12. When clasp 13a and clasp 13b clip together, they form a strong bond and allow the belt to close securely around a user's body.

Pressure point 14 can be attached to rear 15 of belt 12 to be worn towards the middle of the back of the user. Pressure point 14 can be formed of a material for providing comfort to a user. For example, pressure point 14 can be made of plastic and is wrapped around belt 12 on rear 15 of belt 12 so that it lies against a person's body to soften or alleviate pressure caused by wearing belt 12.

Adjustable extension 16 can be attached to belt 12 for adjusting the length of belt 12 so that belt 12 can be worn by people of various girths.

Compartment 20 is coupled to or integral with belt 12 and is configured of a size to enable it to hold currency. Compartment 20 can be closed by closing means 21. Suitable closing means 21 include a zipper, hook and loop material such as Velcro™ or a button. Compartment 20 can be made of a flexible material, such as leather, canvas or plastic. Compartment 20 can be round or rectangular shaped.

Compartment 22 is coupled to or integral with belt 12. Compartment 22 is configured of a size to enable it to hold dog treats. Compartment 22 can be closed by closing means 24. Suitable closing means 24 include a zipper, hook and loop material such as Velcro™ or a button. Compartment 22 can be made of flexible material, such as canvas plastic or cloth. Compartment 22 can be round or rectangular shaped.

Compartment 25 is coupled to or integral with belt 12. Compartment 25 is configured of a size to enable it to receive and store bags for picking up dog waste. Compartment 25 can be elongated to allow at least one but not greater than three bags to be received and stores in compartment 25. Compartment 25 can be closed by closing means 26. Suitable closing means 26 include hook and loop material such as Velcro™ or a pressure-snap. Compartment 25 can be made of a rigid material such as rigid plastic and can be rectangular in shape.

Compartment 27 is coupled to or integral with belt 12. Compartment 27 is configured of a size to enable it to hold a flashlight. Compartment 27 can have a tube shape with top end 28 open and bottom end 29 closed. Compartment 27 can be made of a rigid material such as leather or plastic.

Compartment 30 is coupled to or integral with belt 12. Compartment 30 is configured of a size to enable it to receive and store a mace dispenser or a pocket knife. Compartment 30 can be closed with closing means 31. Suitable closing means 31 include a zipper, hook and loop material such as Velcro™ or a pressure snap. Compartment 30 can be made of a rigid material such as plastic, leather or canvas. Compartment 30 can be tubular in shape so that it can be used to store a mace dispenser or a small pocket knife.

Compartment 32 is coupled to or integral with belt 12. Compartment 32 is configured of a size to enable it to receive and store an umbrella. Compartment 32 can be tube shaped with top end 33 open and bottom end 34 closed. Compartment 32 can be made of a rigid material, such as leather or plastic, and can be tubular in shape so that it can be used to store a small umbrella.

Clip 40 is coupled to or integral with belt 12. Clip 40 is configured of a size to enable it to hold keys or a key chain. Clip 40 can be made of a metal material and include clasp 43. Clasp 43 can be opened and closed to securely receive and hold keys or a key chain.

Clip 44 is coupled to or integral with belt 12. Clip 44 is configured of a size to enable it to hold a clip of a dog leash. Clip 44 can be made of a metal material and includes clasp 45. Clasp 45 can be opened and closed to securely receive and hold dog leash 46, thereby connecting leash 46 to belt 12 to allow a person free use of both their hands to perform other operations, such as picking up the dog's waste.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A pet utility belt comprising:
a belt, said belt having closing means for attaching said belt to a user;
at least one compartment coupled or integral with said belt configured of a size to enable it be hold an item for dog walking; and
a first clip attached to said belt, said first clip adapted to receive a clip of a dog leash.

2. The pet utility belt of claim 1 wherein said at least one compartment is configured of a size to hold currency.

3. The pet utility belt of claim 2 wherein said at least one compartment is closed by a closing means, said closing means being selected from the group consisting of a zipper, hook and loop material, and a button.

4. The pet utility belt of claim 3 wherein said compartment is formed of a flexible material.

5. The pet utility belt of claim 4 wherein said compartment is round or rectangular.

6. The pet utility belt of claim 1 wherein said at least one compartment is configured of a size to hold bags for picking up dog waste.

7. The pet utility belt of claim 1 wherein said at least one compartment is closed by a closing means, said closing means being selected from the group consisting of a hook and loop material and a pressure-snap.

8. The pet utility belt of claim 7 wherein said compartment is formed of a flexible material.

9. The pet utility belt of claim 8 wherein said compartment is round or rectangular.

10. The pet utility belt of claim 1 wherein said at least one compartment is configured of a size to hold a flashlight.

11. The pet utility belt of claim 10 wherein said compartment has a tube shape with an open top end and a closed bottom end.

12. The pet utility belt of claim 11 wherein said compartment is formed of a rigid material.

13. The pet utility belt of claim 1 wherein said at least one compartment is configured of a size to hold a mace dispenser or pocket knife.

14. The pet utility belt of claim 1 wherein said at least one compartment is closed by a closing means, said closing means being selected from the group consisting of a zipper, hook and loop material, or a pressure snap.

15. The pet utility belt of claim 14 wherein said compartment has a tube shape.

16. The pet utility belt of claim 15 wherein said compartment is formed of a rigid material.

17. The pet utility belt of claim 1 wherein said at least one compartment is configured of a size to hold and umbrella.

18. The pet utility belt of claim 17 wherein said compartment has a tube shape with an open top end and a closed bottom end.

19. The pet utility belt of claim 18 wherein said compartment is formed of a rigid material.

20. A pet utility belt comprising:
a belt, said belt having closing means for attaching said belt to a user coupled to said belt;
a first compartment configured in size to hold currency coupled to said belt;
a second compartment configured in size to hold dog treats coupled to said belt;
a third compartment configured in size to hold bags for picking up dog waste coupled to said belt;
a fourth compartment configured in size to hold a flashlight coupled to said belt;
a fifth compartment configured in size to hold a mace dispenser or pocket knife coupled to said belt;
a sixth compartment configured in size to hold an umbrella coupled to said belt; and
a first clip attached to said belt, said first clip configured to received a clip of a dog leash.

21. The pet utility belt of claim 20 further comprising a second clip to receive a key chain.

22. A method for preparing for walking a dog comprising the steps of:
providing a belt, said belt having closing means for attaching said belt to a user coupled to said belt;
filling a first compartment with currency coupled to said belt;
filling a second compartment with dog treats coupled to said belt;
filling a third compartment with bags for picking up dog waste coupled to said belt;
filling a fourth compartment with a flashlight coupled to said belt;
filling a fifth compartment with a mace dispenser or pocket knife coupled to said belt;
filling a sixth compartment with an umbrella coupled to said belt; and
providing a first clip attached to said belt, said first clip configured to received a clip of a dog leash.
